(19) United States
(12) Patent Application Publication
(10) Pub. No.: US 2011/0007221 A1
(43) Pub. Date: Jan. 13, 2011

(54) FILTERING APPARATUS AND DIGITAL BROADCASTING RECEIVING APPARATUS

(75) Inventor: Kenji Tomizawa, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/920,677

(22) PCT Filed: Feb. 4, 2009
(86) PCT No.: PCT/JP2009/052248

§ 371 Date: Sep. 2, 2010

(30) Foreign Application Priority Data
Mar. 12, 2008 (JP) 2008-063127

(51) Int. Cl. G06F 17/30; H04N 5/21

(52) U.S. Cl. 348/725; 707/754; 348/E05.096; 707/E17.009

(57) ABSTRACT

The present invention includes: a condition storage unit including a plurality of N-bit unit storage areas, the condition storage unit configured to store, in the unit storage areas, filter conditions having an M-bit data length according to specific data strings and to store the partial filter conditions, in which the filter conditions are divided every N bits, in the plurality of unit storage areas if the length M bits of the filter conditions is greater than the length N bits of the unit storage areas; a link information register configured to hold link information indicating presence or absence of division denoting whether the data stored in the unit storage areas is a part divided into the partial filter conditions; and a comparing unit configured to perform an equivalent comparison of the filter conditions having an M-bit data length that can be restored based on the corresponding link information and the target data strings to thereby detect whether the specific data strings are included in the target data strings if the data stored in the unit storage areas is the partial filter conditions. This allows efficient section filtering with a small data capacity.

### TECHNICAL FIELD

The present invention relates to a filtering apparatus and a digital broadcasting receiving apparatus suitable for a digital TV, a digital recorder, or the like.

### BACKGROUND ART

In recent years, digital broadcasting employing MPEG-2 standard encoding has been started. A transport stream (TS) defined in the MPEG-2 standard is constituted by 188 byte fixed-length packets (TS packets), and the transport stream can transmit video data, voice data, and other data. Information related to the same type of data is multiplexed in one TS packet, and an identifier (PID) indicating the type of data is attached.

Information called service information (SI) is also transmitted with the TS packets. The service information is transmitted in a structure called a section. One section-structured data (hereinafter “section data”) includes various information such as table number, section length, whether there is an update (version number), and the like. A digital broadcasting receiving apparatus refers to a PID from sequentially inputted TS packets, filters TS packets with the same PID, and further filters section data according to predetermined conditions.

The section filter used for filtering the section data sets information (table number or the like) to be specified in the section data as a condition (filter condition) and can detect the section data including the specific information by comparing the coincidence between the input data and the filter condition. Setting a plurality of filter conditions to detect a plurality of section data allows filtering various section data using the section filter.

Among the values (hereinafter “data patterns”) possessed by the data included in the section data, data having a specific data pattern included only in the section data is usually set to the filter condition. For example, if the length of data including the specific data pattern is 8 bytes (64 bits), the filter condition requires at least 8 bytes in length.

Setting the number of configurable filter conditions (hereinafter “the number of filters”) to, for example, eight allows to filter eight types of section data having a specific data pattern of up to 8 bytes in length.

The filter conditions used for designating the specific data pattern are called AND conditions (reference data) or the like.

However, the length of data required for specifying is different depending on the type of the section data. Therefore, conventionally, a length that could specify roughly all section data is assumed in advance so that up to a common length can be specified in all filter conditions.

Thus, if the length of the filter conditions assumed in advance is m bits and the number of filters is n, at least a storage element, such as a memory and a register, with an m×n bit capacity is required as a section filter to store the filter conditions (hereinafter, a memory will be described representatively).

In this way, integrating the length of the filter conditions in all filters makes it unnecessary to store the length of each filter condition. Furthermore, a method of using MASK conditions described below allows to generally use a memory area in all filter conditions regardless of the length of the filter conditions up to m bits. In other words, a certain filter condition is not dedicated for detecting a certain specific data pattern. Therefore, the integration of the length of the filter conditions in all filters can simplify the filter structure.

When a certain data pattern can be specified without using the data of part of the AND conditions, MASK conditions (mask data) are also used as filter conditions for designating not to use part or all of the data of the AND conditions.

For example, if the value of an AND condition is 4′b1111 and the value of a MASK condition is 4′b0001, data patterns that can be specified by the conditions are 4′1111 and 4′b1110 (“4′b” is a prefix code indicating that the subsequent values are written in 4-bit binary). Thus, it shows that the data of the AND condition at locations where the MASK condition indicates “1” is not used to specify the data pattern. In other words, a designation is made to detect data of all patterns that the values of the data at the locations (two ways, “0” and “1”, in the example) can be.

As in the example, although the length of the MASK condition per filter condition is generally the same as the length of the AND condition, the length can be changed in accordance with a unit of the length of the data range that can be designated not to be used. For example, if the unit is 1 bit, the same length as the AND condition is necessary, and if the unit is 1 byte (8 bits), a length equivalent to one eighth of the AND condition is necessary. To facilitate understanding, the lengths of the data of the AND condition and the MASK condition are the same in the following description.

In the example, although the effective polarity of the MASK condition is “1” and the AND condition is not used at this time, the effective polarity may be “0”, and the example may provide 4′b1110 as a MASK condition. To facilitate understanding, the effective polarity of the MASK condition is “1” in the following description.

Although the example includes two types of filter conditions, AND condition and MASK condition, three or more types of conditions can also be used to increase methods for comparison with target data strings to thereby increase the flexibility of detection. For example, Japanese Patent Application Laid-Open Publication No. 2005-190312 (hereinafter “Document 1”) proposes a section filter using four types, AND conditions, MASK conditions, NOT conditions (not conditions), and NGRP conditions (group conditions). For example, the NOT conditions can compare the non-coincidence with the AND conditions, and more data patterns than in the coincidence comparison can be detected. To facilitate understanding, there are two types of filter conditions, AND conditions and MASK conditions, in the following description.

As described, in the conventional section filter, memory areas configured to respectively store the filter conditions are constituted in logically the same length.

However, the length of the specific data required to filter the section data using the filter conditions stored in the memory is different depending on the type of the section data, as described above.

In such a case, the data patterns with different lengths can be specified by invalidating the data of part of the AND conditions by the MASK conditions. However, if only filter conditions having the same length as the data to be specified are stored in the memory, the data of the AND conditions invalidated by the MASK conditions were supposed to be unnecessary.

Now, a section filter will be considered in which the length of one filter condition is 8 bytes. In this case, the lengths of the AND condition and the MASK condition are 8 bytes, and a specific example of the data pattern specified using the conditions is 0x00010203_XXXXXXXX (“X” is a code denoting an arbitrary 4-bit value, “0x” is a prefix code indicating that the subsequent values are written in hexadecimal, and “_” is a code inserted to facilitate visual check of the value). Thus, the first 4 bytes are specific data in this example. In the example, the section data including the data patterns to be specified can be detected by setting the AND condition to 0x00010203_{—}00000000 and the MASK condition to 0x00000000_FFFFFFFF. Thus, a data pattern that can satisfy any data pattern is designated for 4 bytes of the 8 bytes that can be designated as a filter condition.

In this case, if the length of the data to be specified is shorter than the maximum length of the filter conditions that can be stored in the memory, there is a part in which a filter condition that satisfies any data needs to be designated.

If only a filter condition having the same length as the data to be specified is stored in the memory, the part is an area that could have been used to store other filter conditions, and the part will be called a surplus part.

Therefore, when the length of the filter condition assumed in advance is set to the maximum length of the data to be specified, there are many surplus parts if section data with a length smaller than the length of the data to be specified is often detected, resulting in an unnecessarily large circuit.

On the contrary, if the length of the filter condition assumed in advance is set to the minimum length of the data to be specified to prevent the surplus part, data patterns with lengths larger than the minimum length cannot be specified.

An example of a method for solving the problems includes Japanese Patent Application Laid-Open Publication No. 2002-185960, which proposes a method of preventing an increase in the size of the circuit configured to hold conditions by holding comparison location information for designating with which byte of the condition a comparison will be made. However, there are problems in the proposal in that the size of the circuit configured to hold the comparison location information according to the number of filters and the length of the data to be specified is large and that the control is cumbersome because the comparison locations must be sequentially designated in all filters.

### DISCLOSURE OF INVENTION

### Means for Solving the Problem

A filtering apparatus of one aspect of the present invention is configured to detect one or more specific data strings included in target data strings, the filtering apparatus including: a condition storage unit including a plurality of unit storage areas with a first bit number, the condition storage unit configured to store, in the unit storage areas, one or more filter conditions having a data length with a bit number respectively corresponding to the one or more specific data strings and to store a plurality of partial filter conditions, in which the filter conditions are divided every first bit number, in the plurality of unit storage areas if the bit number of the filter conditions is greater than the first bit number of the unit storage areas; a link information register configured to hold link information indicating presence or absence of division denoting whether the data stored in the unit storage areas is part of the filter conditions divided into the partial filter conditions; and a comparing unit configured to compare the filter conditions that can be restored based on the corresponding link information and the target data strings to thereby detect whether the specific data strings are included in the target data strings if the data stored in the unit storage areas is the partial filter conditions.

A digital broadcasting receiving apparatus of one aspect of the present invention includes: an input unit inputted with a digital broadcasting stream; a first filter used for filtering packets including a predetermined identifier from the packets constituting the inputted digital broadcasting stream; a second filter, to which part or all of the packets filtered using the first filter are inputted as target data strings, configured to detect packets including one or more specific data strings included in the target data strings, the second filter including: a condition storage unit including a plurality of unit storage areas with a first bit number, the condition storage unit configured to store, in the unit storage areas, one or more filter conditions having a data length with a bit number respectively corresponding to the one or more specific data strings and to store a plurality of partial filter conditions, in which the filter conditions are divided every first bit number, in the plurality of unit storage areas if the bit number of the filter conditions is greater than the first bit number of the unit storage areas; a link information register configured to hold link information indicating presence or absence of division denoting whether the data stored in the unit storage areas is part of the filter conditions divided into the partial filter conditions; and a comparing unit configured to compare the filter conditions that can be restored based on the corresponding link information and the target data strings to thereby detect whether the specific data strings are included in the target data strings if the data stored in the unit storage areas is the partial filter conditions; an output unit configured to output part or all of the packets filtered using the first filter or the second filter; a video decoder configured to decode video data outputted by the output unit; an audio decoder configured to decode voice data outputted by the output unit; and a host processor configured to execute a receiving process of a digital broadcasting signal based on section data outputted by the output unit.

### BRIEF DESCRIPTION OF THE DRAWINGS

FIG. 1 is a block diagram showing a filtering apparatus according to a first embodiment of the present invention;

FIG. 2 is an explanatory view showing a specific configuration of an AND condition storage unit 21 in FIG. 1;

FIG. 3 is an explanatory view showing a specific configuration of the AND condition storage unit 21 in FIG. 1;

FIG. 4 is an explanatory view showing a specific configuration of an AND condition storage unit in a conventional technique;

FIG. 5 is a block diagram showing a second embodiment of the present invention;

FIG. 6 is an explanatory view showing a four-link pattern in the second embodiment;

FIG. 7 is a block diagram showing a third embodiment of the present invention;

FIG. 8 is an explanatory view showing a four-link pattern in the third embodiment;

FIG. 9 is a block diagram showing a fourth embodiment of the present invention;

FIG. 10 is a block diagram showing a fifth embodiment of the present invention; and

FIG. 11 is a block diagram showing a sixth embodiment of the present invention.

### BEST MODE FOR CARRYING OUT THE INVENTION

Hereinafter, embodiments of the present invention will be described in detail with reference to the drawings.

### First Embodiment

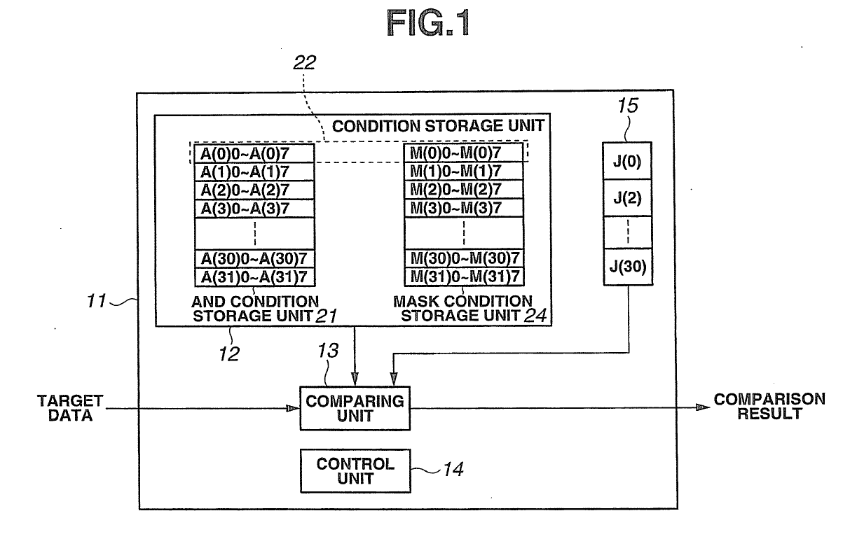

FIG. 1 is a block diagram showing a filtering apparatus according to a first embodiment of the present invention.

A filtering apparatus 11 is constituted by a condition storage unit 12, a comparing unit 13, a control unit 14, and a link information register 15. Target data is inputted to the comparing unit 13. When data to be filtered using the present filtering apparatus is transmitted by a broadcasting stream in an ARIB (Association of Radio Industries and Business) standard, a part or all of TS packets filtered using a PID filter is inputted as target data to the comparing unit 13.

In the condition storage unit 12, filter conditions are stored in unit storage areas that are logical areas in a memory. In the present embodiment, the length (capacity) of the unit storage areas is 8 bytes in a specific example, and an example will be described in which there are 32 such areas. The areas are distinguished by numbers 0 to 31.

In the present embodiment, if the length of the filter conditions is longer than the length of the unit storage areas, the filter conditions are divided every unit storage area length, and the parts of the divided filter conditions (hereinafter referred to as “partial filter conditions”) are divided into two or more unit storage areas and stored.

If the length of the filter conditions is equal to or shorter than the length of the unit storage areas, the filter conditions are stored in one unit storage area.

In the present embodiment, the filter conditions are divided and stored when the filter conditions are 9 bytes or more, and up to two divisions are performed. Thus, in the example, up to 16 bytes can be compared as data to be specified.

In the partial filter conditions or the filter conditions shorter than the length of the unit storage areas, data with a data pattern satisfying any data pattern is interpolated to adapt the length with the length of the unit storage areas.

The condition storage unit 12 further includes an AND condition storage unit 21 and a MASK condition storage unit 24. The AND condition storage unit 21 is configured to store AND conditions among the filter conditions, while the MASK condition storage unit 24 is configured to store MASK conditions among the filter conditions.

The unit storage areas 22 include filter conditions stored in Nos. k (k=0 to 31) areas, or AND conditions A(k) and MASK conditions M(k) of the partial filter conditions. Each unit storage area 22 includes AND conditions: 8 bytes from A(k)0 to A(k)7 and MASK conditions corresponding to the byte locations: 8 bytes from M(k)0 to M(k)7.

The link information register 15 stores presence or absence of division.

In the present embodiment, Nos. 2t (t=0 to 15, thus, even numbers 0, 2, 4, . . . , and 30) unit storage areas 22 are respectively allocated with areas J(2t) for storing presence or absence of division.

When one filter condition is divided (in case of presence of division) into Nos. 2t and Nos. 2t+1 unit storage areas, the values of J(2t) are set to “1”, and when not divided (in case of absence of division), the values are set to “0”, thereby the presence or absence of division is stored. Therefore, the lengths (capacities) of the J(2t) areas can be at least 1 bit.

The presence or absence of division is used by the comparing unit 13 as link information.

The comparing unit 13 is sequentially provided with filter conditions from the condition storage unit 12, compares the target data with the sequentially inputted filter conditions, and outputs the result.

In this case, two or more partial filter conditions are regarded as one filter conditions based on the link information before being compared.

The possibility of the detection of a specific pattern or the number of the filter condition coinciding with the specific data pattern is outputted as a comparison result.

The comparison result outputted from the comparing unit 13 is not limited to the number of the filter condition coinciding with the specific data pattern. For example, a number that did not coincide can also be consciously outputted. In any case, it would be sufficient if whether the target data includes the specific data pattern can be determined, and information necessary for the determination is outputted.

Various output formats are also possible, and there is no specific limitation in the present embodiment.

For example, if Nos. 0 to 31 (6′b000000 to 6′b011111) are to be notified as the numbers of the coincided filter conditions (filter conditions satisfying the specific data pattern), the fact of no detection is expressed by a number out of the range of the filter condition numbers, for example 32 (6′b100000), and it can be outputted in 6-bit binary (“6b” is a prefix code indicating that the subsequent values are written in 6-bit binary).

Alternatively, it can be outputted as a 32-bit value with the values of the bits at locations of the same number as the number of the coincided filter conditions being “1”. For example, when the counting is started from the LSB bit with No. 0, if the coincided filter number is No. 0, the output value is 32′h0000_{—}0001. If the coincided filter number is No. 15, the output value is 32′h0000_{—}8000. If the coincided filter number is No. 16, the output value is 32′h8000_{—}0000. If the coincided filter numbers are both No. 0 and No. 15, the output value is 32′h0000_{—}8001 (“32′h” is a prefix code indicating that the subsequent values are written in 32-bit hexadecimal). Although the bit numbers (circuit size) are increased compared to when the filter number itself is notified in binary, there is an advantage that the numbers of all coincided filter conditions (or filter numbers) can be notified simultaneously.

The control unit 14 reads or writes the filter conditions in the condition storage unit 12, supplies the filter conditions, link information, and target data to the comparing unit 13, reads or writes the link information in the link information register 15, and performs control necessary for activating the filtering apparatus 11. Signals necessary for the control are not illustrated.

Effects of the link information register will be described in comparison with a conventional technique.

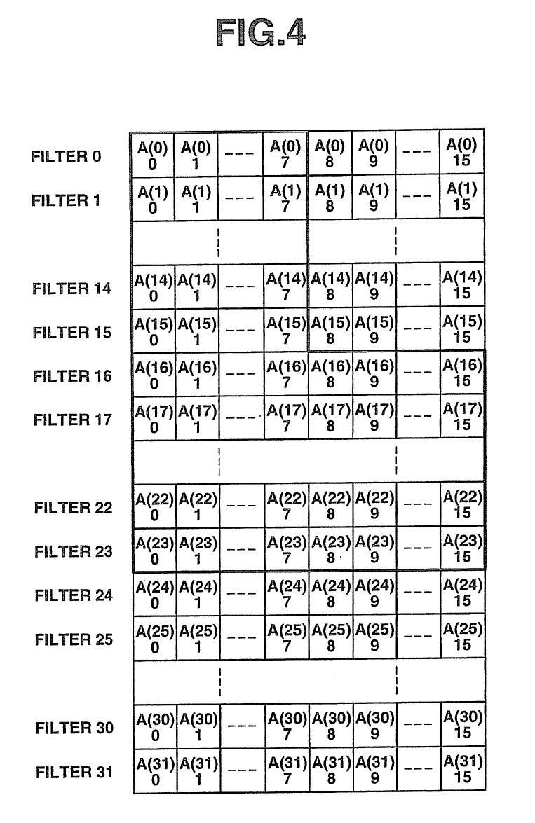

FIG. 4 shows a situation of filter conditions stored in the condition storage unit 12 of the conventional technique.

In FIG. 4, areas in the conventional technique equivalent to the unit storage areas 22 of the condition storage unit 12 are 16 bytes, and FIG. 4 shows a situation of the AND condition storage unit 21 including 32 areas. Thus, FIG. 4 shows an example of AND conditions A(k)0 to A(k)15 (k denotes integers 0 to 31) with 16 byte length in each unit storage area. Although not shown, the MASK conditions also have 16 byte length.

In the conventional technique, since one filter condition is stored in one unit storage unit, 32 unit storage areas corresponding to Nos. 0 to 31 filter conditions are arranged. To facilitate understanding, Nos. k filter conditions are stored in Nos. k unit storage areas in the description.

Now, a case will be considered in which sixteen data with 8 byte length and eight data with 16 byte length need to be specified.

Assuming that filter conditions for specifying 8 byte-length data are stored in Nos. 0 to 15 areas of the unit storage areas and filter conditions for specifying 16 byte-length data are stored in Nos. 16 to 23 areas, at least the data of filter conditions surrounded by a thick frame in FIG. 4 is required for specifying.

Thus, 8 bytes of A(k)0 to A(k)7 are required in Nos. k=0 to 15 AND conditions, and 16 bytes of A(k)0 to A(k)15 are required in Nos. k=16 to 23 AND conditions.

In Nos. k=0 to 15 AND conditions, 8 bytes of A(k)8 to A(k)15 are surplus parts for storing data of data patterns satisfying any data pattern.

Nos. 24 to 31 unit storage areas are unused parts that are not used in this example. In other words, effective filter conditions are not stored in the areas.

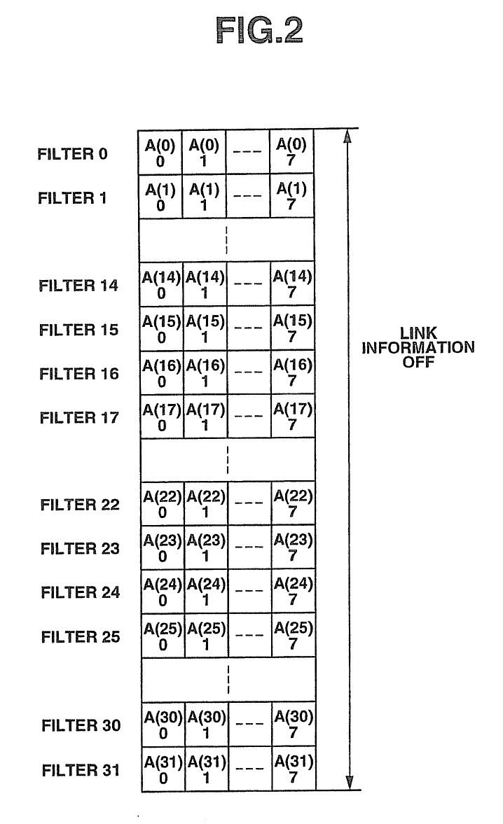

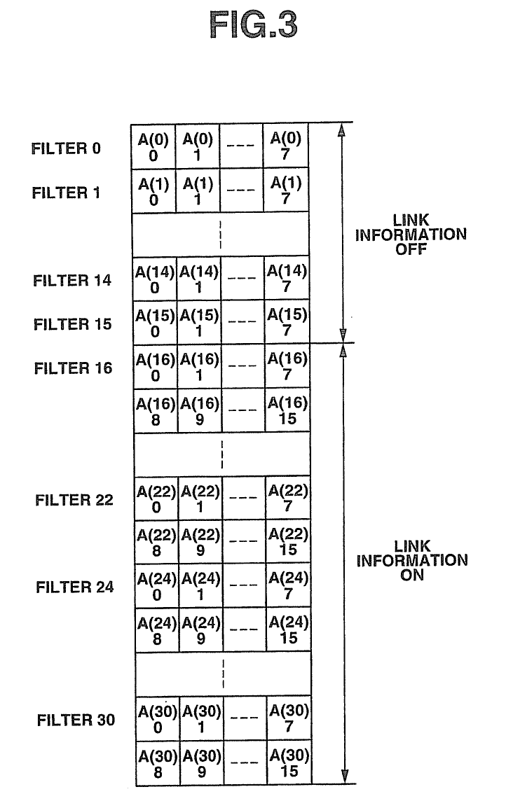

FIGS. 2 and 3 show situations of the filter conditions stored in the condition storage unit 12 in the present embodiment.

In FIGS. 2 and 3, the length of the areas equivalent to the unit storage areas 22 of the condition storage unit 12 is 8 bytes, and FIGS. 2 and 3 show situations of the AND condition storage unit 21 including 32 areas. Thus, FIGS. 2 and 3 show examples including 8-byte AND conditions A(k)0 to A(k)7 (k denotes integers 0 to 31) with 8 byte length in each unit storage area. Although not shown, the MASK conditions also have 8 byte length.

In the present embodiment, one filter condition is stored in one or more unit storage areas. Therefore, unlike the conventional technique, the number of the filter conditions that can be stored and the number of the unit storage areas do not necessarily correspond.

For example, if one filter condition is stored in one unit storage area as in the conventional technique, all areas J(0) to J (30) of the link information register 15 are “0” (link information OFF) as shown in FIG. 2, and 32 8-byte filter conditions can be stored.

To facilitate understanding, the filter conditions stored in Nos. k unit storage areas or the filter conditions in which the first partial filter conditions are stored in Nos. k unit storage areas will be described as Nos. k filter conditions.

In the present embodiment, using Nos. 2t and 2t+1 (t=0 to 15) unit storage areas allows to divide one filter condition into up to two before storing.

When the filter condition is divided, areas J(2t) corresponding to Nos. 2t unit storage areas of the link information register are “1” (link information ON). When the filter condition is not divided, J(2t) are “0”.

Now, a case will be considered in which sixteen data with 8 byte length and eight data with 16 byte length need to be specified, as in the conventional technique.

It is assumed that the filter condition for specifying the 8 byte-length data are divided and stored in Nos. 0 to 15 areas of the unit storage areas and that the filter condition for specifying the 16 byte-length data are divided and stored in Nos. 16 to 31 areas.

In this case, as shown in FIG. 3, the values of the link information register corresponding to Nos. 0 to 15 unit storage areas are link information OFF, and the values of the link information register corresponding to Nos. 16 to 31 are link information ON.

Thus, the first partial filter conditions of Nos. 2q filter conditions are stored in Nos. 2q (q=8 to 15, thus, even number 16, 18, . . . , and 30) unit storage areas in which the link information is ON, and the second partial filter conditions of Nos. 2q filter conditions are stored in Nos. 2q+1 unit storage areas.

Nos. 2p filter conditions are stored in Nos. 2p (p=0 to 7, thus, even numbers 0, 2, . . . , and 14) unit storage areas in which the link information is OFF, and Nos. 2p+1 filter conditions are stored in Nos. 2p+1 (odd numbers 1, 3, . . . , and 15) unit storage areas that are logically consecutive with Nos. 2p unit storage areas.

The unit storage areas in which the link information is ON will be described in more details, taking the AND conditions as an example.

Nos. 0 byte to 7 byte AND conditions of Nos. 2q filters: A(2q)0 to A(2q)7 are stored in the AND conditions of Nos. 2q unit storage areas: A(2q)0 to A(2q)7, and

Nos. 8 byte to 15 byte AND conditions of Nos. 2q filters: A(2q)8 to A(2q)15 are stored in the AND conditions of Nos. 2q+1 unit storage areas: A(2q+1)0 to A(2q+1)7.

Nos. 2q+1 filter conditions in FIG. 2 are used as the partial filter conditions of Nos. 2q filter conditions in FIG. 3. As a result, it can also be expressed that a 16 byte-length filter condition is stored.

Specifically, No. 16 AND conditions: A(16)0 to A(16)15 are divided and stored in the AND condition section of No. 16 unit storage area and the AND condition section of No. 17 unit storage area.

Similarly, Nos. 18, 20, 22, . . . , and 30 AND conditions are divided and stored in Nos. 18, 20, 22, . . . , 30 unit storage areas and Nos. 19, 21, 23, . . . 31 unit storage areas.

Storing the MASK conditions in a similar way allows to store 8 16 byte-length filter conditions in 16 unit storage areas 22.

The specific data example described above is equivalent to an example in which 24 types in total of section data are filtered (16 types that can be specified by 8-byte filter conditions and 8 types that can be specified by 16-byte filter conditions).

In the present embodiment (FIG. 3), the capacity required for the memory included in the condition storage unit 12 is at least 8 bytes(length of unit storage areas)×32(the number of filters)×2(the number of types of filter conditions)=512 bytes(4096 bits).

As described above, it would be sufficient if there is at least 1 bit of link information in the present embodiment, and the total capacity of the link information register 15 can be 2 bytes (16 bits).

On the other hand, in the conventional technique (FIG. 4), the capacity required for the memory included in the condition storage unit 12 is at least 16 (length of unit storage areas), in which the unused parts are excluded, ×24(the number of filters)×2(the number of types of filter conditions)=768 bytes (6144 bits).

Obviously, there is no link information register 15 in the conventional technique.

Therefore, according to the present embodiment, 768−512+2=254 bytes (2032 bits) of the total capacity of the memory or register can be reduced compared to the conventional technique.

Thus, the decrease in the memory capacity (size) included in the condition storage unit 12 as a result of preventing the surplus part is larger than the increase in the circuit size by the link information register 15, and the effect is apparent.

Although the first embodiment has been described, the present embodiment is not limited to the configuration. Various modifications are possible within the scope of the claims, and the present embodiment includes all these modifications.

For example, when the control unit 14 supplies filter conditions to the comparing unit 13, a method of sequentially supplying Nos. 1 to 31 filter conditions in numeric order of the filter conditions and a method of supplying only the filter conditions with some of the numbers can be considered, and the present embodiment includes both cases.

Furthermore, although there are two types of filter conditions, AND conditions and MASK conditions, it is apparent that configurations, in which the filter conditions are constituted by one type or three or more types of conditions, are also similarly applicable, and the present embodiment also includes these.

### Second Embodiment

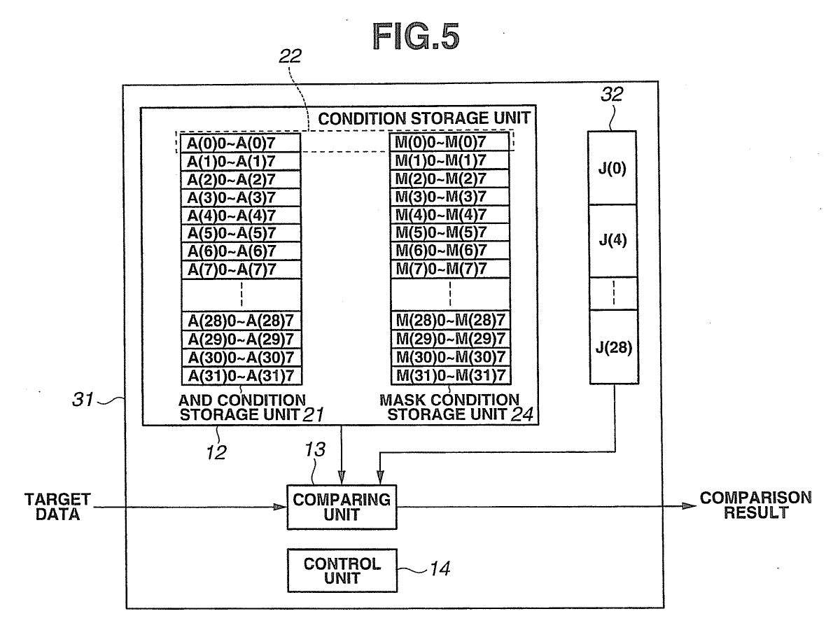

FIG. 5 is a block diagram showing a second embodiment of the present invention. In FIG. 5, the same constituent elements as in FIG. 1 are designated with the same reference numerals, and the description will be omitted.

To further facilitate understanding, the conditions are the same as in the first embodiment unless otherwise stated.

In FIG. 1, an example of two-link has been described in which the link information register 15 allocated with 1 bit for every two unit storage area is employed, and the partial filter conditions can be divided into up to two unit storage areas. The number of the partial filter conditions that can be divided can be determined by the length of a specific data pattern to be detected by the filtering apparatus or receiving apparatus applied with the present embodiment, or can be determined from the distribution. In the present embodiment, an example of four-link will be illustrated in which division into up to four partial filter conditions is possible.

The filtering apparatus 31 in the present embodiment is different from the first embodiment in that a link information register 32 is employed in place of the link information register 15.

Thus, the presence or absence of division is stored in the link information register 32, and in the present embodiment, areas J(4t) configured to store the presence or absence of division are respectively allocated to Nos. 4t (t=0 to 7, thus, even numbers 0, 4, 8, . . . , 28) unit storage areas 22.

The values of J(4t) denote into how many consecutive unit storage areas the filter conditions stored from Nos. 4t unit storage areas are divided. The present embodiment shows an example in which filter conditions can be stored in the condition storage unit 12 after being divided into up to four partial filter conditions. Thus, the lengths (capacities) of the areas of J(4t) in the link information register 32 can be at least 2 bits.

To facilitate understanding, the values of J(4t) are set in four ways (0 to 3), and No. 0 is used as a specific example of Nos. 4t to further describe the method of dividing the filter conditions.

For example, when J(0)=3, the filter conditions are stored after being divided into four consecutive unit storage areas. The first partial filter condition of No. 0 filter condition is stored in No. 0 unit storage area. The second partial filter condition of No. 0 filter condition is stored in No. 1 unit storage area. The third partial filter condition of No. 0 filter condition is stored in No. 2 unit storage area. The fourth partial filter condition of No. 0 filter condition is stored in No. 3 unit storage area.

Thus, in this case, No. 0 filter condition with a data length (length of filter condition) of up to 32 bytes can be stored.

When J(0)=2, the filter conditions are stored after being divided into three consecutive unit storage areas. The first partial filter condition of No. 0 filter condition is stored in No. 0 unit storage area. The second partial filter condition of No. 0 filter condition is stored in No. 1 unit storage area. The third partial filter condition of No. 0 filter condition is stored in No. 2 unit storage area. No. 3 filter condition is stored in No. 3 unit storage area.

Thus, in this case, No. 0 filter condition with a length of up to 24 bytes and No. 3 filter condition with a length of up to 8 bytes can be stored.

In case of J(0)=1, the filter conditions are stored after being divided into two consecutive unit storage areas. The first partial filter condition of No. 0 filter condition is stored in No. 0 unit storage area. The second partial filter condition of No. 0 filter condition is stored in No. 1 unit storage area. No. 2 filter condition is stored in No. 2 unit storage area. No. 3 filter condition is stored in No. 3 unit storage area.

Thus, in this case, No. 0 filter condition with a length of up to 16 bytes and No. 2 and No. 3 filter conditions with a length of up to 8 bytes can be stored.

When J(0)=0, the filter conditions are stored without being divided. No. 0 filter condition is stored in No. 0 unit storage area. No. 1 filter condition is stored in No. 1 unit storage area. No. 2 filter condition is stored in No. 2 unit storage area. No. 3 filter condition is stored in No. 3 unit storage area.

Thus, in this case, Nos. 0, 1, 2, and 3 filter conditions with a length of up to 8 bytes can be stored.

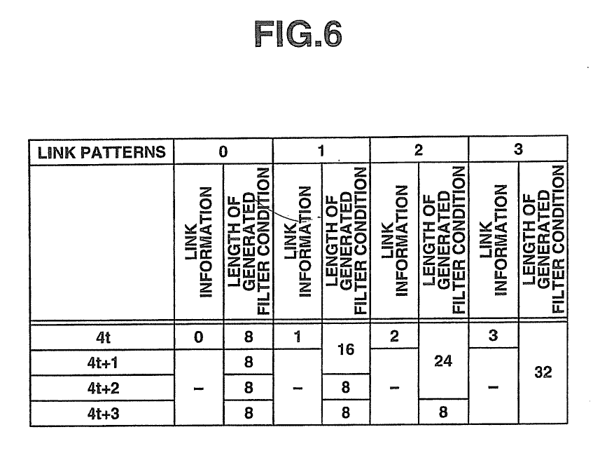

FIG. 6 is an explanatory view showing a four-link pattern in the present embodiment. FIG. 6 shows data lengths (byte numbers) of the filter conditions that can be divided and stored in accordance with the link information J(k) (k=integers 0 to 31) of Nos. 4t, 4t+1, 4t+2, and 4t+3 unit storage areas 22.

Thus, there are four types, 0 to 3, of link patterns that the value of J(4t) can take, as described above. In case of “0”, 8-byte filter conditions can be stored in Nos. 4t, 4t+1, 4t+2, and 4t+3 unit storage areas. In case of “1”, 16-byte filter conditions, in which Nos. 4t and 4t+1 unit storage areas are linked, can be stored, and 8-byte filter conditions can be stored in Nos. 4t+2 and 4t+3 unit storage areas. In case of “2”, 24-byte filter conditions, in which Nos. 4t to 4t+2 unit storage areas are linked, can be stored, and 8-byte filter conditions can be stored in Nos. 4t+3 unit storage areas. In case of “3”, 32-byte filter conditions, in which Nos. 4t to 4t+3 unit storage areas are linked, can be stored.

In the present embodiment, increasing the number of links than in the first embodiment (two-link) can prevent the surplus part even if the data length of the filter conditions is significantly longer than the length of the unit storage areas.

### Third Embodiment

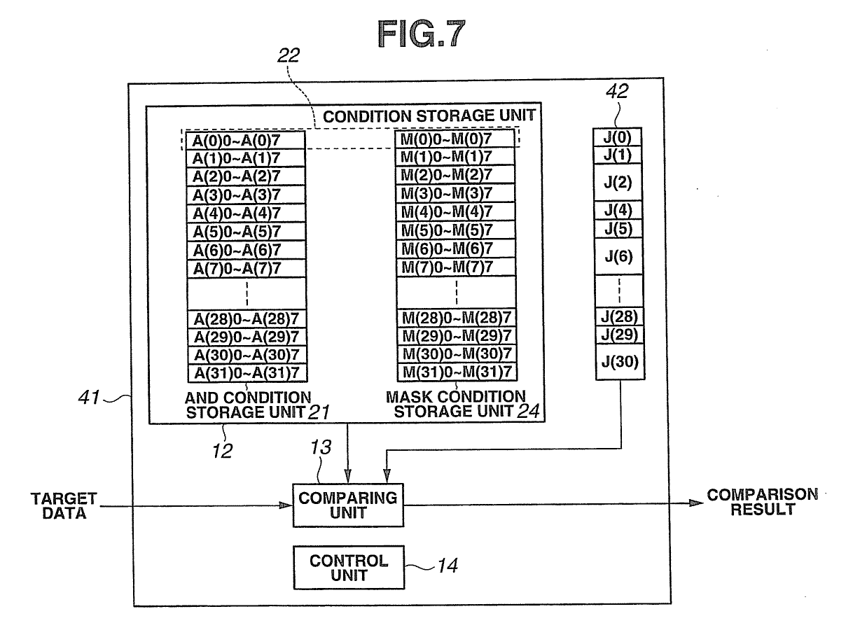

FIG. 7 is a block diagram showing a third embodiment of the present invention. In FIG. 7, the same constituent elements as in FIG. 1 are designated with the same reference numerals, and the description will be omitted.

To further facilitate understanding, the conditions are the same as in the first embodiment unless otherwise stated.

The present embodiment illustrates an example in which the number of surplus parts that can be used as section filters having filter conditions with data lengths of 16 bytes and 24 bytes are increased compared to the second embodiment.

A filtering apparatus 41 of the present embodiment is different from the second embodiment in that a link information register 42 is employed in place of the link information register 32.

Thus, the presence or absence of division is stored in the link information register 42, and in the present embodiment, areas J(p) configured to store the presence or absence of division is allocated to each of Nos. p=4t, 4t+1, and 4t+2 (t=0 to 7, thus, P=numbers 0, 1, 2, 4, 5, 6, . . . , 28, 29, and 30) unit storage areas 22.

In other words, J(q) (q=numbers 3, 7, 11, . . . , and 31) are not allocated to Nos. q=4t+3 unit storage areas 22 as areas for storing the presence or absence of division.

As in the first embodiment, when all or part of one filter condition is divided into Nos. 4t and 4t+1 unit storage areas, the values of J(4t) are “1”. When all or part of one filter condition is divided into Nos. 4t+1 and 4t+2 unit storage areas, the values of J(4t+1) are “1”. When all or part of one filter condition is divided into Nos. 4t+2 and 4t+3 unit storage areas, the values of J(4t+2) are “1”. When not divided, the values are “0”. The presence or absence of division is stored this way. Therefore, the lengths (capacities) of the J(p) areas can be at least 1 bit.

As in the second embodiment, to facilitate understanding, No. 0 is used as a specific example of Nos. 4t to further describe the method of dividing the filter conditions.

For example, when J(0)=1, J(1)=0, and J(2)=0, the first partial filter condition of No. 0 filter condition is stored in No. 0 unit storage area. The second partial filter condition of No. 0 filter condition is stored in No. 1 unit storage area. No. 2 filter condition is stored in No. 2 unit storage area. No. 3 filter condition is stored in No. 3 unit storage area.

Thus, in this case, No. 0 filter condition with a length of up to 16 bytes and Nos. 2 and 3 filter conditions with a length of up to 8 bytes can be stored.

When J(0)=1, J(1)=1, and J(2)=0, the first partial filter condition of No. 0 filter condition is stored in No. 0 unit storage area. The second partial filter condition of No. 0 filter condition is stored in No. 1 unit storage area. The third partial filter condition of No. 0 filter condition is stored in No. 2 unit storage area. No. 3 filter condition is stored in No. 3 unit storage area.

Thus, in this case, No. 0 filter condition with a length of up to 24 bytes and No. 3 filter condition with a length of up to 8 bytes can be stored.

When J(0)=1, J(1)=1, and J(2)=1, the first partial filter condition of No. 0 filter condition is stored in No. 0 unit storage area. The second partial filter condition of No. 0 filter condition is stored in No. 1 unit storage area. The third partial filter condition of No. 0 filter condition is stored in No. 2 unit storage area. The fourth partial filter condition of No. 0 filter condition is stored in No. 3 unit storage area.

Thus, in this case, No. 0 filter condition with a length of up to 32 bytes can be stored.

When J(0)=0, J(1)=1, and J(2)=0, No. 0 filter condition is stored in No. 0 unit storage area. The first partial filter condition of No. 1 filter condition is stored in No. 1 unit storage area. The second partial filter condition of No. 1 filter condition is stored in No. 2 unit storage area. No. 3 filter condition is stored in No. 3 unit storage area.

Thus, in this case, Nos. 0 and 3 filter conditions with a length of up to 8 bytes and No. 1 filter condition with a length of up to 16 bytes can be stored.

When J(0)=1, J(1)=0, and J(2)=1, the first partial filter condition of No. 0 filter condition is stored in No. 0 unit storage area. The second partial filter condition of No. 0 filter condition is stored in No. 1 unit storage area. The first partial filter condition of No. 2 filter condition is stored in No. 2 unit storage area. The second partial filter condition of No. 2 filter condition is stored in the No. 3 unit storage area.

Thus, in this case, Nos. 0 and 2 filter conditions with a length of up to 16 bytes can be stored.

When J(0)=0, J(1)=1, and J(2)=1, No. 0 filter condition is stored in No. 1 unit storage area. The first partial filter condition of No. 1 filter condition is stored in No. 1 unit storage area. The second filter condition of No. 1 filter condition is stored in No. 2 unit storage area. The third partial filter condition of No. 1 filter condition is stored in No. 3 unit storage area.

Thus, in this case, No. 0 filter condition with a length of up to 8 bytes and No. 1 filter condition with a length of up to 24 bytes can be stored.

When J(0)=0, J(1)=0, and J(2)=1, No. 0 filter condition is stored in No. 0 unit storage area. No. 1 filter condition is stored in No. 1 unit storage area. The first partial filter condition of No. 2 filter condition is stored in No. 2 unit storage area. The second partial filter condition of No. 2 filter condition is stored in No. 3 unit storage area.

Thus, in this case, Nos. 0 and 1 filter conditions with a length of up to 8 bytes and No. 2 filter condition with a length of up to 24 bytes can be stored.

When J(0)=0, J(1)=0, and J(2)=0, No. 0 filter condition is stored in No. 0 unit storage area. No. 1 filter condition is stored in No. 1 unit storage area. No. 2 filter condition is stored in No. 2 unit storage area. No. 3 filter condition is stored in No. 3 unit storage area.

Thus, in this case, Nos. 0, 1, 2, and 3 filter conditions with a length of up to 8 bytes can be stored.

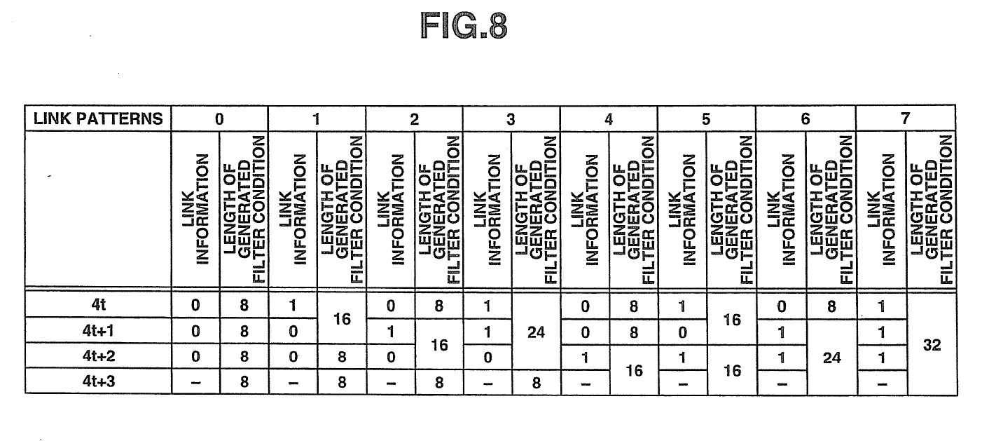

FIG. 8 is an explanatory view showing a four-link pattern in the present embodiment. As in FIG. 6, FIG. 8 shows data lengths (byte numbers) of the filter conditions that can be divided and stored in accordance with the link information J(k) (K=integers 0 to 31) of Nos. 4t, 4t+1, 4t+2, and 4t+3 unit storage areas 22. There are eight link patterns in total. As compared to the second embodiment (FIG. 6), it can be understood that the link patterns capable of storing up to 16-byte filter conditions are increased to four ways (1, 2, 4, and 5), and the link patterns capable of storing up to 24-byte filter conditions are also increased to two ways (3 and 6).

At least 2 (bit number of link information required for four-link-unit)×8 (the number of unit storage areas in which up to four links are possible)=16 bits of total capacity is required for the link information register 32 of the second embodiment (FIG. 5), and the total capacity of the link information register 42 of the present embodiment (FIG. 7) is at least 3×8=24 bits. Thus, although the total capacity of the link information register increases by 8 bits from the second embodiment, the third embodiment handles the division and storage of 16-byte and 24-byte filter conditions by more link patterns than in the second embodiment, which also forms the four-link, with a significantly small increase in the circuit size compared to the decrease (256 bytes=2048 bits) in the memory included in the condition storage unit 12 described in the first embodiment (FIG. 1).

As described, in the present embodiment, information to be stored in the link information register, which is whether all or part of one filter condition is divided and stored in logically consecutive unit storage areas, is consecutively stored in Nos. 4t, 4t+1, and 4t+2 areas. As a result, even if the data length of the filter condition is significantly longer than the unit storage area, the number of times of using the surplus part (link patterns) as a storage area of a filter condition with relatively high use frequency, such as 8-byte or 16-byte, can be increased compared to the second embodiment, which also forms the four-link.

### Fourth Embodiment

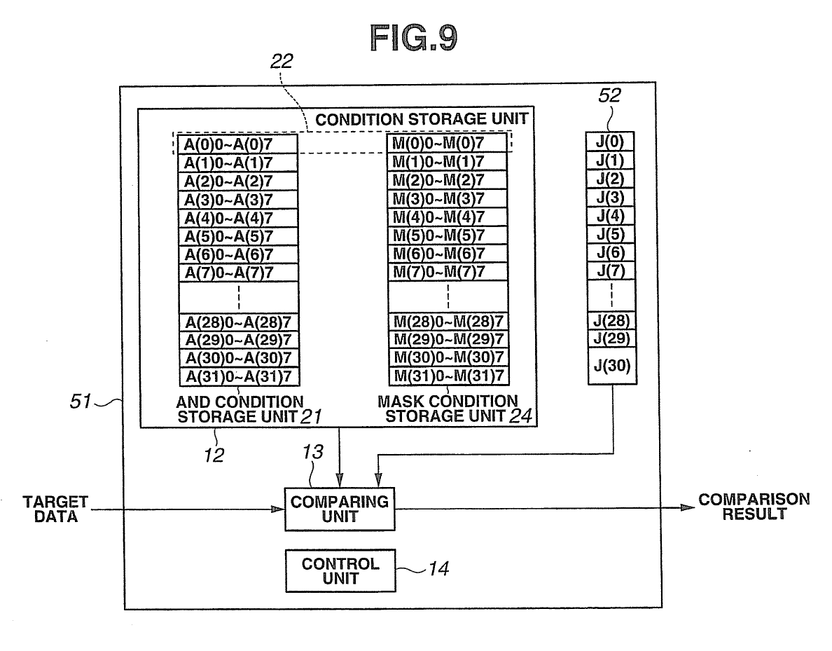

FIG. 9 is a block diagram showing a fourth embodiment of the present invention. In FIG. 9, the same constituent elements as in FIG. 1 are designated with the same reference numerals, and the description will be omitted.

To further facilitate understanding, the conditions are the same as in the first embodiment unless otherwise stated.

The present embodiment illustrates an example in which filter conditions longer than 32 bytes can be divided and stored.

A filtering apparatus 51 in the present embodiment is different from the first embodiment in that a link information register 52 is employed in place of the link information register 15.

Thus, the presence or absence of division is stored in the link information register 52, and in the present embodiment, areas J(p) configured to store the presence or absence of division are respectively allocated to Nos. p=0 to 30 unit storage areas 22.

In other words, an area J(31) for storing the presence or absence of division is not allocated to No. 31 unit storage area 22.

As in the first embodiment, when all or part of one filter conditions is divided into Nos. t and t+1 (t=0 to 30) unit storage areas, the values of J(t) are “1”, and when not divided, the values are “0”. The presence or absence of division is stored this way. Therefore, the lengths (capacities) of the J(p) areas can be at least one bit.

As in the second embodiment, to facilitate understanding, No. 0 is used as a specific example of Nos. t to further describe the method of dividing the filter conditions. In the present embodiment, although 8 bytes×32=256-byte filter conditions are divided and stored when the values of J(0) to J(30) are all “1”, there are many other link patterns, and it is difficult to further describe all patterns. Since the method of linking is the same as in the third embodiment, only one example will be further described herein.

For example, when J(0)=J(1)=J(2)=J(3)=J(4)=1 and J(5)=0, the first partial filter condition of No. 0 filter condition is stored in No. 0 unit storage area. The second partial filter condition of No. 0 filter condition is stored in No. 1 unit storage area. The third partial filter condition of No. 0 filter condition is stored in No. 2 unit storage area. The fourth partial filter condition of No. 0 filter condition is stored in No. 3 unit storage area. The fifth partial filter condition of No. 0 filter condition is stored in No. 4 unit storage area. The sixth partial filter condition of No. 0 filter condition is stored in No. 5 unit storage area.

In this case, No. 0 filter condition with a length of up to 48 bytes can be stored.

Thus, the maximum length of the filter conditions that can be divided and stored can be extended according to the number of consecutive J(p) with values “1”.

In the above example, five consecutive numbers of link information J(0) to J(4) are “1” before J(5) with value “0”, and 8(length per unit storage area)+8(length per unit storage area)×5(consecutive numbers)=48 bytes is the maximum length of No. 0 filter condition that can be divided and stored.

If J(t) to J(t+6) are consecutively “1” and J(t+7) is “0”, then No. t filter condition with a length of up to 64 bytes can be stored.

In this way, the same effects as in the first embodiment can be obtained in the present invention, and filter conditions with a length larger than 24 bytes and 32 bytes can be divided and stored.

### Fifth Embodiment

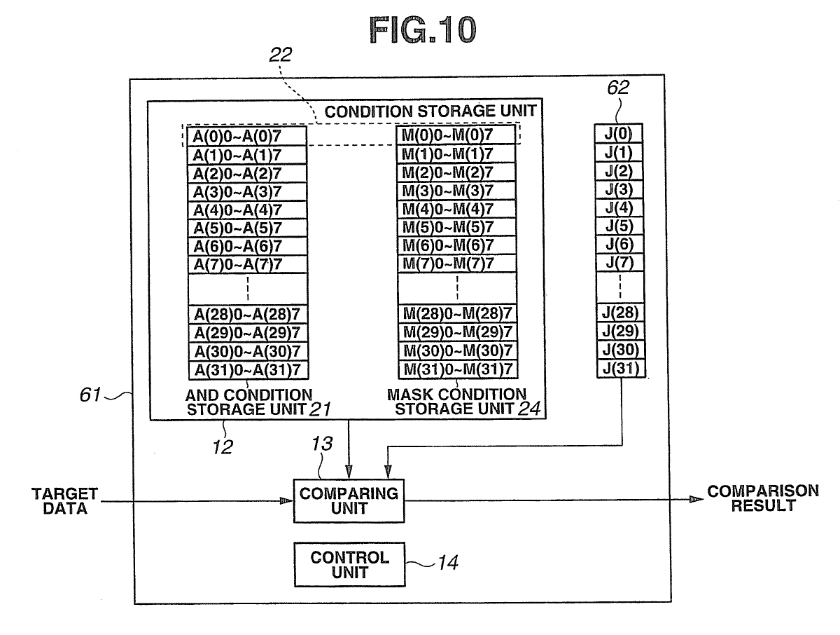

FIG. 10 is a block diagram showing a fifth embodiment of the present embodiment. In FIG. 10, the same constituent elements as in FIG. 1 are designated with the same reference numerals, and the description will be omitted.

To further facilitate understanding, the conditions are the same as in the first embodiment unless otherwise stated.

The present embodiment illustrates an example that can divide and store filter conditions with a length larger than 32 bytes by using an arbitrary number of unit storage area. The degree of freedom of selecting a unit storage area as storage of partial filter conditions is improved in the example compared to the fourth embodiment.

A filtering apparatus 61 in the present embodiment is different from the first embodiment in that a link information register 62 is employed in place of the link information register 15.

Thus, the presence or absence of division is stored in the link information register 62, and in the present embodiment, areas J(p) configured to store the presence or absence of division are respectively allocated to all numbers p=0 to 31 unit storage areas 22.

Unlike the previous embodiments, when all or part of one filter condition is divided into Nos. x and y unit storage areas, the values of J(x) are “y”, and when not divided, the values are “x”. The presence or absence of division is stored this way. Therefore, the lengths (capacities) of J(p) areas can be at least 5 bits.

As in the second embodiment, to facilitate understanding, specific examples of Nos. x and y are used to further describe the method of dividing the filter conditions. In the present invention, if all of the values of J(0) to J(31) are the same numbers as corresponding unit storage areas, 8 bytes×32=256 bytes of filter conditions are divided and stored. However, there are many other link patterns, and it is difficult to further describe all of the patterns. Since the method of linking is easy, only one example will be further described herein.

For example, when link information J(0)=10, J(10)=20, J(20)=30, J(30)=40, J(40)=50, and J(50)=50,

one filter condition is divided into partial filter conditions and stored in Nos. 0, 10, 20, 30, 40, and 50 unit storage areas. More specifically, the first partial filter condition of No. 0 filter condition is stored in No. 0 unit storage area. The second partial filter condition of No. 0 filter condition is stored in No. 10 unit storage area. The third partial filter condition of No. 0 filter condition is stored in No. 20 unit storage area. The fourth partial filter condition of No. 0 filter condition is stored in No. 30 unit storage area. The fifth partial filter condition of No. 0 filter condition is stored in No. 40 unit storage area. The sixth partial filter condition of No. 0 filter condition is stored in No. 50 unit storage area.

Thus, in this case, No. 0 filter condition with a length of up to 48 bytes can be stored.

Thus, the maximum length of the filter conditions that can be divided and stored can be extended according to the number of consecutive J(p) in which the values are different from the corresponding numbers of the unit storage areas.

In the above example, five pieces of link information J(0), J(10), J(20), J(30), and J(40) before J(50), in which the value is the same as the corresponding number (No. 50) of the unit storage area, are linked, and 8 (length per unit storage area)+8 (length per unit storage area)×5 (the number of linkages)=48 bytes is the maximum length of No. 0 filter condition that can be divided and stored.

In this way, the same effects as in the first embodiment can be obtained in the present embodiment, and filter conditions with a length larger than 24 bytes and 32 bytes can be divided and stored using an arbitrary number of unit storage area. An arbitrary number of unit storage area is set when the filter conditions are divided into two or more partial filter conditions and then stored. As a result, there will be no case as in the second and third embodiments in which No. 4t+3 can be automatically used only as a place for storing 8 byte-filter conditions when Nos. 4t filter conditions with a length of 24 bytes is stored in Nos. 4t to 4t+2. This can improve the degree of freedom of combining the unit storage areas during division.

### Sixth Embodiment

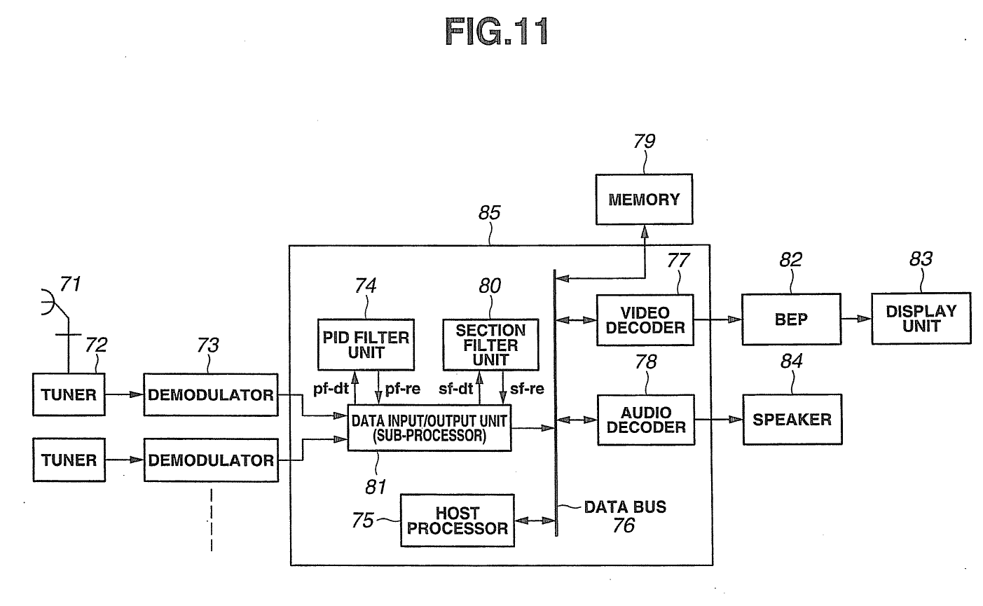

FIG. 11 shows a sixth embodiment of the present invention and is a block diagram showing a digital broadcasting receiving apparatus incorporated with a filtering apparatus according to the embodiments described above.

In FIG. 11, at least a PID filter unit 74, a section filter unit 80, a host processor 75, a video decoder 77, an audio decoder 78, and a data bus 76 are formed on a same chip 85.

As shown in FIG. 11, stream data by a radio frequency is inputted to a tuner 72 through an antenna 71. The tuner 72 converts the inputted radio frequency signal to a baseband signal and outputs the signal to a demodulator 73. The demodulator 73 applies a demodulation process to the inputted baseband signal and outputs TS made of TS packets to a data input/output unit 81. The demodulation process includes, for example, a conversion from an analog signal to a digital signal, demultiplexing and demodulating when a received signal is multiplexed and modulated, and an error correction process. In a receiving apparatus equipped with two or more tuners, the antenna 71 is similarly connected to the tuners, or other antennas not shown are connected to the tuners.

The data input/output unit 81 includes at least one input port for receiving TS from the demodulator 73 and is provided with at least the following functions.

1. Receive TS inputted from the input port and identify TS packets.

2. Extract information (at least one of PID, input port number, and the like) for specifying TS packets multiplexed with desired data (data required to play digital broadcasting programs) from the identified TS packets and output the information as comparison data pf-dt to the PID filter unit 74.

3. Receive a comparison result pf-re outputted from the PID filter unit 74, and according to the values, filter TS packets including desired data.

4. If the desired data included in the filtered packets is video data or audio data, output a part including at least the data to the data bus 76.

5. If the desired data included in the filtered packets is section data, further extract information for specifying (at least one of table number, version number, and the like), and output the information as comparison data sf-dt to the section filter unit 80.

6. Receive a comparison result sf-re outputted from the section filter unit 80, and according to the values, output a part including at least the section data to the data bus 76.

The video decoder 77, the audio decoder 78, the host processor 76, and a memory 79 as well as the data input/output unit 81 are connected to the data bus 76.

The video data, the audio data, and the section data outputted from the data input/output unit 81 to the output data bus 76 are supplied to the video decoder 77, the audio decoder 78, and the host processor 75 through a dedicated buffer area installed in the memory 79. Although not shown, the video decoder 77, the audio decoder 78, and the host processor 75 may be designed to directly import the output data from the data input/output unit 81 without the memory 79.

The video decoder 77 decodes the imported video data and outputs the obtained video information to a back end processor (BEP) 82. The back end processor 82 applies various image processing such as color correction to the video information and causes a display unit 83 to display the information. The audio decoder 78 decodes the imported audio data and plays the obtained voice information from a speaker 84.

The PID filter unit 74 includes at least one or more filter conditions (hereinafter “PID filter conditions”), and at least a value of PID included in the TS packets to be filtered is set in each filter condition. Preset PID filter conditions and the comparison data pf-dt outputted from the data input/output unit 81 are compared, and the comparison result pf-re is outputted to the data input/output unit 81.

The section filter unit 80 includes at least one or more filter conditions (hereinafter “section filter conditions”), and at least a value the same as a specific data pattern included in the section data to be filtered is set in the AND conditions in each filter condition. Preset section filter conditions and the comparison data sf-dt outputted from the data input/output unit 81 are compared, and the comparison result sf-re is outputted to the data input/output unit 81.

Thus, the section filter unit 80 is constituted by the filtering apparatus according to the above embodiments.

Specifically, the “target data” shown in the block diagrams (FIGS. 1, 5, 7, 9, and 10) of the embodiments described above is equivalent to the comparison data sf-dt of FIG. 11, and the “comparison result” of the block diagrams is equivalent to the comparison result sf-re of FIG. 11.

A link information register is also included, and the presence or absence of division of the filter condition is stored in the register. An equivalent comparison with the filter conditions before division is performed based on the link information of the link information register according to the numbers of the unit storage areas.

As can be seen, it has been described that the filtering apparatus according to the above embodiments can be applied to a digital broadcasting receiving apparatus.

Lastly, a method of equivalently comparing by assuming two or more partial filter conditions as one filter condition based on the link information, thus, a configuration of the comparing unit 13, will be further described.

There are roughly two equivalent comparison methods. For example, describing using the two-link of the first embodiment,

one of the methods is a method of linking (combining) two partial filter conditions to restore a 16-byte filter condition and then comparing the restored condition with 16-byte target data.

Another method is a method of comparing the first partial filter condition with the first 8 bytes of the 16 bytes of the target data and then integrating with the comparison result of the first 8 bytes when the second partial filter condition is compared with the second 8 bytes of the 16 bytes of the target data.

Thus, the former is a method of comparing after restoring the filter condition (hereinafter “restoration comparison”), and the latter is a method of integrating the comparison results of the unit storage areas (hereinafter “integration comparison).

The format of the comparison result required for integration (result for integration) may be different from the format of the comparison result of the final output (result for final).

This is because, in a configuration of returning a filter number as the result for final, it may be desirable that the result for integration be set in a state of whether the partial filter conditions are satisfied type by type.

The NOT condition in Document 1 will be considered as an example. The definition of the NOT condition is “the NOT condition is satisfied when there is at least one bit in the target data that does not coincide with the AND condition among the bits at the same locations as the designated bits”.

Therefore, when bits designated with the NOT condition exist in both of the first 8 bytes and the second 8 bytes,

in the bits designated with the NOT condition, even if there is no bit that does not coincide with the AND condition in the first 8 bytes, the condition of 16-byte target data is satisfied if there is even 1 bit that does not coincide with the AND condition in the second 8 bytes.

In this case, if the integration is attempted after obtaining the final comparison result in the first 8 bytes, the cause of not satisfying is in the NOT condition or in the AND condition (bits not designated with the NOT condition) cannot be determined. Therefore, correct integration with the comparison result of the second 8 bytes cannot be performed.

Thus, in the integration comparison, the results for integration should be obtained in advance in some cases according to the types of conditions to be used to obtain the final comparison result by integrating the results.

The present embodiment can be applied to both of the comparing unit in a restoration comparison configuration and the comparison unit in an integration comparison configuration, and the present embodiment includes both cases.

The present application is filed on the basis of claiming the benefit of priority from Japanese Patent Application No. 2008-63127, filed on Mar. 12, 2008 in Japan, and the disclosed contents are incorporated in the present specification, claims, and drawings by reference.

1. A filtering apparatus configured to detect one or more specific data strings included in target data strings, the filtering apparatus comprising:
a condition storage unit including a plurality of unit storage areas with a first bit number, the condition storage unit configured to store, in the unit storage areas, one or more filter conditions having a data length with a bit number respectively corresponding to the one or more specific data strings and to store a plurality of partial filter conditions, in which the filter conditions are divided every first bit number, in the plurality of unit storage areas if the bit number of the filter conditions is greater than the first bit number of the unit storage areas;
a link information register configured to hold link information indicating presence or absence of division denoting whether the data stored in the unit storage areas is part of the filter conditions divided into the partial filter conditions; and
a comparing unit configured to compare the filter conditions that can be restored based on the corresponding link information and the target data strings to thereby detect whether the specific data strings are included in the target data strings if the data stored in the unit storage areas is the partial filter conditions.

2. The filtering apparatus according to claim 1, wherein
the link information register includes one area for storing the link information, corresponding to one or a plurality of the unit storage areas.

3. The filtering apparatus according to claim 2, wherein
the link information register holds one-bit information as the link information.

4. The filtering apparatus according to claim 3, wherein
the link information register includes one area for storing the one-bit link information every two unit storage areas.

5. The filtering apparatus according to claim 3, wherein
the link information register includes (n−1) areas for storing the one-bit link information every n (n is a natural number 3 or more) unit storage areas.

6. The filtering apparatus according to claim 3, wherein
the link information register includes areas for storing the one-bit link information indicating the presence or absence of division, corresponding to each of the plurality of unit storage areas.

7. The filtering apparatus according to claim 2, wherein
the link information register holds information of a plurality of bits as the link information.

8. The filtering apparatus according to claim 7, wherein
the link information held by the link information register includes information indicating into how many partial filter conditions the filter conditions have been divided.

9. The filtering apparatus according to claim 7, wherein
the link information register includes one area for storing information indicating into how many partial filter conditions the filter conditions have been divided in each of the plurality of unit storage areas.

10. The filtering apparatus according to claim 7, wherein
the link information held by the link information register is for designating addresses of the unit storage areas.

11. The filtering apparatus according to claim 1, wherein
the link information register holds the one-bit link information indicating the presence or absence of division in each of one or more areas corresponding to the plurality of unit storage areas, and
the comparing unit compares the filter conditions stored in one or more unit storage areas, in which combinations of the filter conditions that can be divided and stored are predefined, among the one or more unit storage areas or the filter conditions that can be restored from the plurality of partial filter conditions based on the link information nation and the target data strings.

12. The filtering apparatus according to claim 1, wherein
the filter conditions include a plurality of types of conditions to increase the flexibility of detection by increasing methods for comparison with the target data strings.

13. The filtering apparatus according to claim 11, wherein
the filter conditions include a plurality of types of conditions to increase the flexibility of detection by increasing methods for comparison with the target data strings.

14. The filtering apparatus according to claim 1, wherein
the target data strings are part or all of section data multiplexed to packets constituting a digital broadcasting stream.

15. The filtering apparatus according to claim 11, wherein
the target data strings are part or all of section data multiplexed to packets constituting a digital broadcasting stream.

16. The filtering apparatus according to claim 12, wherein
the target data strings are part or all of section data multiplexed to packets constituting a digital broadcasting stream.

17. The filtering apparatus according to claim 13, wherein
the target data strings are part or all of section data multiplexed to packets constituting a digital broadcasting stream.

18. A digital broadcasting receiving apparatus comprising:
an input unit inputted with a digital broadcasting stream;
a first filter used for filtering packets including a predetermined identifier from the packets constituting the inputted digital broadcasting stream;
a second filter, to which part or all of the packets filtered using the first filter are inputted as target data strings, configured to detect packets including one or more specific data strings included in the target data strings, the second filter including: a condition storage unit including a plurality of unit storage areas with a first bit number, the condition storage unit configured to store, in the unit storage areas, one or more filter conditions having a data length with a bit number respectively corresponding to the one or more specific data strings and to store a plurality of partial filter conditions, in which the filter conditions are divided every first bit number, in the plurality of unit storage areas if the bit number of the filter conditions is greater than the first bit number of the unit storage areas; a link information register configured to hold link information indicating presence or absence of division denoting whether the data stored in the unit storage areas is part of the filter conditions divided into the partial filter conditions; and a comparing unit configured to compare the filter conditions that can be restored based on the corresponding link information and the target data strings to thereby detect whether the specific data strings are included in the target data strings if the data stored in the unit storage areas is the partial filter conditions;
an output unit configured to output part or all of the packets filtered using the first filter or the second filter;
a video decoder configured to decode video data outputted by the output unit;
an audio decoder configured to decode voice data outputted by the output unit; and
a host processor configured to execute a receiving process of a digital broadcasting signal based on section data outputted by the output unit.
